(19) United States
(12) Patent Application Publication
(10) Pub. No.: US 2009/0129668 A1
(43) Pub. Date: May 21, 2009

(54) Image-recognition method and system using the same

(75) Inventor: Cheng-Jan Chi, Taipei City (TW)

Correspondence Address: BACON & THOMAS, PLLC, 625 SLATERS LANE, FOURTH FLOOR, ALEXANDRIA, VA, 22314-1176, US

(73) Assignee: ASUSTEK COMPUTER INC., Taipei City (TW)

(21) Appl. No.: 11/898,104

(22) Filed: Sep. 10, 2007

(30) Foreign Application Priority Data
Oct. 14, 2006 (TW) 095137915

(51) Int. Cl. G06K 9/62

(52) U.S. Cl. 382/161

(57) ABSTRACT

An image-recognition method and a system using the method is disclosed, which proceeds comparison through the visual lingual characteristics according to the logic of lingual vocabulary of an image to be recognized to reduce the number of the objects to be compared, and to select at least one object. After that, similarity comparison between a graphic characteristic of the image to be recognized and at least one graphic sample corresponding to the object selected is proceeded. And then, at least one graphic sample is selected to achieve open frame image recognition.

### BACKGROUND OF THE INVENTION

1. Field of the Invention

This invention relates to an image-recognition method and a system using the same and, more particularly, to an image-recognition method adapted for an open frame and a system using the same.

2. Description of the Related Art

Nowadays, an image-recognition system only can recognize the image of specific fields such as a handwritten-character recognition system, a human face recognition system, a license-number recognition system, a fingerprint recognition system, and so on.

A conventional image-recognition system utilizes closed frames, that is, it only records finite graphic data of a specific field. When an image is to be recognized, the conventional image-recognition system obtains characteristics of the image. Then, it determines similarity between the characteristics and the finite graphic data, and selects the graphic data which is most similar to the characteristics as a recognition result. Thus, the image recognition is completed.

The field of the conventional image-recognition system is limited. The reason is that for establishing an image-recognition system of an unspecific limited field, an algorithm of an open frame should be established first. That is, if an image of an unspecific field is to be recognized, infinite graphic data for comparison should be established first in the image recognition system. However, it will be unpractical because of the divergence of the graphic data of the image-recognition system. Therefore, no image-recognition system for the open frame can be practically used nowadays.

### BRIEF SUMMARY OF THE INVENTION

One objective of the invention is to provide an image-recognition method and a system using the same by which the image can be recognized according to the logic of lingual vocabularies.

Another objective of the invention is to provide an image-recognition method and a system using the same by which the image of the open frame can be recognized according to the logic of visual vocabularies.

The other objective of the invention is to provide an image-recognition method and a system using the same by which the number of the compared objects can be rapidly decreased according to the comparison logic of visual lingual characteristics.

To achieve the above objectives, the embodiment of the invention provides an image-recognition method. A database which records a plurality of objects, at least one visual lingual characteristic corresponding to the objects and at least one graphic sample corresponding to the objects is used in the method. The method includes following steps: receiving an image to be recognized; determining at least one visual lingual characteristic of the image; selecting at least one object corresponding to at least one graphic sample from the database according to the visual lingual characteristics, and at least one graphic sample corresponding to the object; and comparing the image with the selected graphic sample. In the embodiment of the invention, the visual lingual characteristic can be the visual vocabulary of human beings for describing the visual characteristics of images, appearance or spatial location relationships, and the visual lingual characteristic can also be a noun, adjective, or a corresponding comparative degree.

To achieve the above objectives, the embodiment of the invention also provides an image-recognition system. A database is used in the system. The database records a plurality of objects, at least one visual lingual characteristic and at least one graphic sample. The system includes an image scanning unit for scanning an image to be recognized, a storage unit for storing a database, and a central process unit for executing a computer program to determine at least one visual lingual characteristic of an image to be recognized. In the database, at least one object and at least one graphic sample corresponding to the objects are selected according to the visual lingual characteristics, and the graphic sample will be compared with the image to be recognized.

To achieve the above objectives, the embodiment of the invention further provides a computer readable storage medium with a computer program. The computer program is used for an image-recognition database recording a plurality of objects, at least one visual lingual characteristic corresponding to the objects, and at least one graphic sample corresponding to the objects. Wherein, the above computer program mainly includes codes for determining at least one visual lingual characteristic of an image to be recognized, codes for selecting at least one object from the database according to the visual lingual characteristics and at least one graphic sample corresponding to the object, and codes for comparing the graphic sample with the image to be recognized.

In the embodiment of this invention, the visual vocabulary can be “dimension”, “size”, “shape”, “color”, or “brightness”.

In the embodiment of this invention, the steps for comparing the image to be recognized with the graphic sample can include extracting at least one graphic characteristic of the image to be recognized and comparing the graphic characteristic of the image to be recognized with that of the graphic sample.

### BRIEF DESCRIPTION OF THE DRAWINGS

FIG. 1 is a flowchart of a preferred embodiment of this invention.

FIG. 2 is a schematic diagram showing a database of a preferred embodiment of this invention.

FIG. 3A is a schematic diagram showing the image of a piece of “white” paper.

FIG. 3B is a schematic diagram showing the graphic characteristic extracted by the image-recognition method of a preferred embodiment of this invention according to the image shown in FIG. 3A.

FIG. 4A is a schematic diagram showing the image of an Arabic number 3.

FIG. 4B is a schematic diagram showing the graphic characteristic extracted by the image-recognition method of a preferred embodiment of this invention according to the image shown in FIG. 4A.

FIG. 5A is a schematic diagram showing a graphic sample of a preferred embodiment of this invention.

FIG. 5B is a schematic diagram showing a graphic sample of a preferred embodiment of this invention.

FIG. 6A is a schematic diagram showing a graphic template of a preferred embodiment of this invention.

FIG. 6B is a schematic diagram showing a graphic template of a preferred embodiment of this invention.

FIG. 7 is a schematic diagram showing an image-recognition system of a preferred embodiment of this invention.

### DETAILED DESCRIPTION OF THE EMBODIMENTS

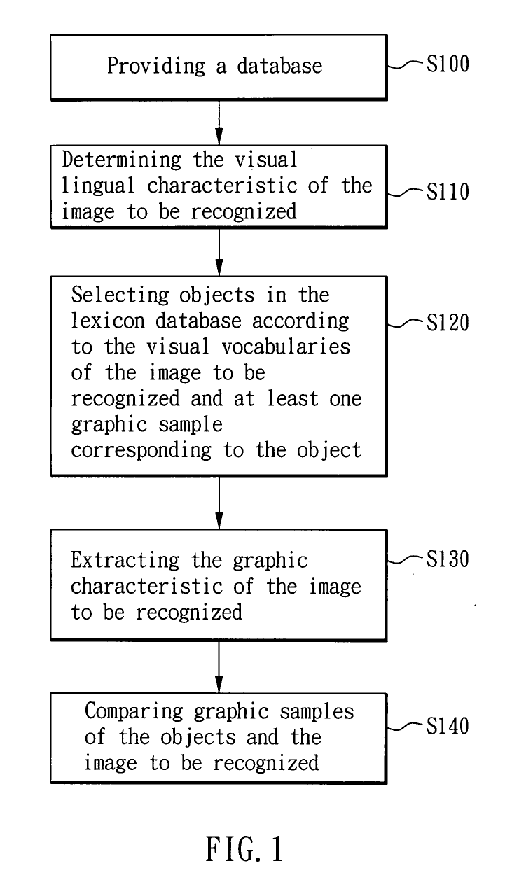

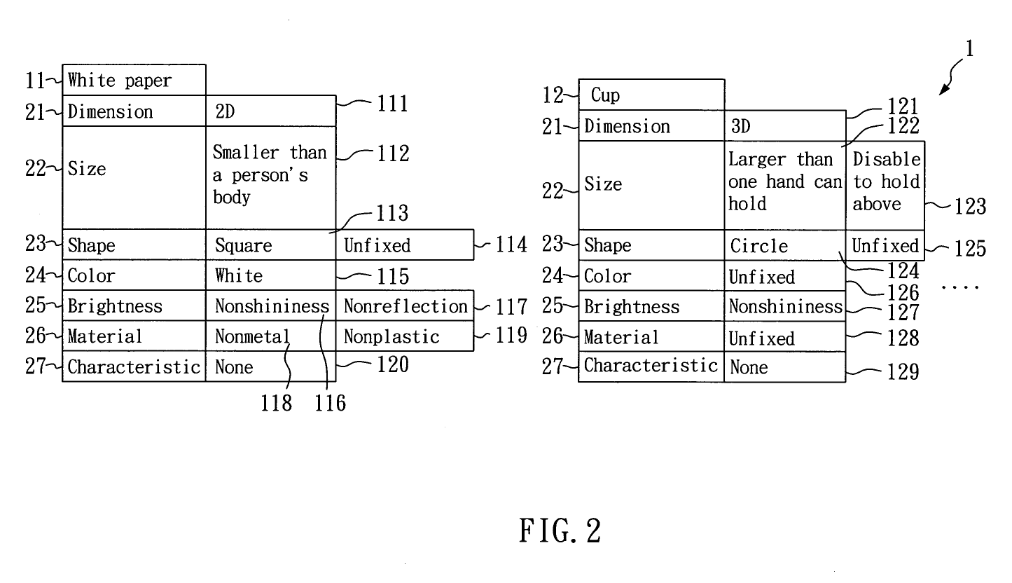

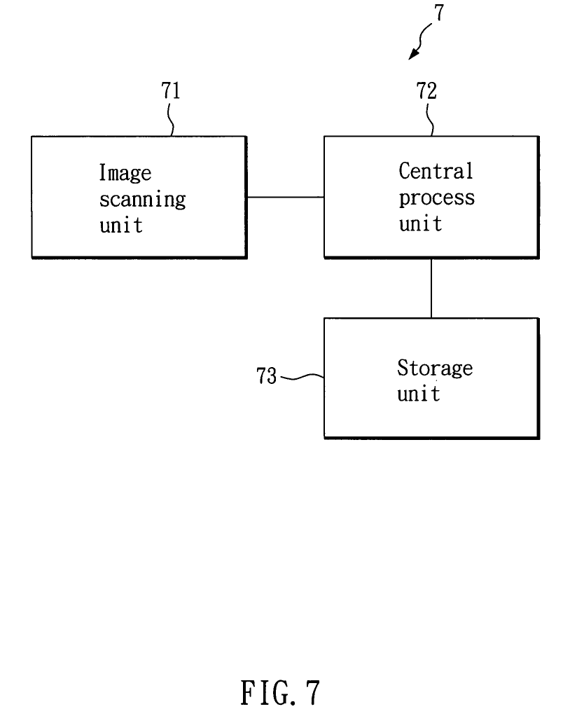

Please refer to FIG. 1 showing the flowchart of a preferred embodiment of this invention. As shown in FIG. 1, a database 1 is used in the image-recognition method of the embodiment. Please refer to FIG. 2 and FIG. 7 simultaneously. FIG. 2 shows the database 1 of a preferred embodiment of this invention, and FIG. 7 is a schematic diagram showing an image-recognition system of a preferred embodiment of this invention.

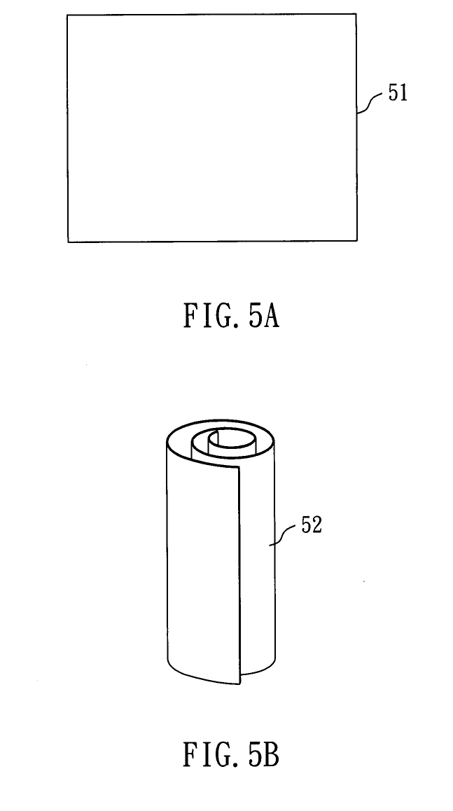

The database 1 is stored in a storage unit 73 of the image-recognition system 7, and records objects 11 and 12, visual lingual characteristics 111˜120 and 121˜129, and graphic samples 51 and 52 (shown in FIG. 5A and FIG. 5B). Wherein, the object 11 corresponds to the visual lingual characteristics 111˜120, and the object 12 corresponds to the visual lingual characteristics 121˜129.

In this embodiment, the visual lingual characteristics 111˜120 and 121˜129 corresponding to the objects 11 and 12 in the database 1 belong to the visual vocabularies 21˜27 of the character and language for describing visual characteristics of images or spatial location relationships of human beings. The visual lingual characteristics 111˜120, 121˜129 can be noun, adjective, or a corresponding comparative degree.

The visual vocabularies 23, 24, 25, 26, 27 of the database 1 of the embodiment can include “dimension”, “size”, “shape”, “color”, “brightness”, “material”, and “characteristic”. The visual lingual characteristics 111˜120, 121˜129 of the objects corresponding to above visual vocabulary 21, 22, 23, 24, 25, 26, 27 are recorded in the database 1.

For example, when the visual vocabulary is “dimension”, it includes the visual lingual characteristics such as “1D”, “2D”, “3D”, and/or “unfixed”, and so on. The object stored in the database has visual lingual characteristics corresponding to the visual vocabulary “dimension”. When the visual vocabulary is “size”, it includes the visual lingual characteristics such as “larger than one hand can hold”, “smaller than two hands can hold”, “smaller than a person's body”, “a bit bigger than a person's body”, “much bigger than a person's body”, and/or “unfixed”, and so on.

Similarly, if the visual vocabulary is “shape”, the visual language nature can include “circle”, “triangle”, “square”, “unfixed”, and so on. When the visual vocabulary is “color”, the visual lingual characteristics can include “white”, “black”, “red”, “multicolor”, “unfixed”, and so on. When the visual vocabulary is “brightness”, the visual lingual characteristics can include “shininess”, “reflection”, “nonshininess”, “nonreflection”, “unfixed”, and so on. When the visual vocabulary is “material”, the visual lingual characteristics can include “metal”, “plastics”, “nonmetal”, “nonplastics”, “unfixed”, and so on. When the visual vocabulary is “characteristic”, the visual language nature can include “sharp angle”, “depression”, “none”, and so on.

For example, as shown in FIG. 2, the object 11 is “white paper”, and the visual lingual characteristic 111 corresponds to the visual vocabulary 21 “dimension” is “2D”. Similarly, the object 12 is “cup”, and the visual lingual characteristic can correspond to a comparative degree. For example, the visual lingual characteristics 122, 123 correspond to the visual vocabulary 22 “size” are “larger than one hand can hold” and “smaller than two hands can hold”, respectively.

According to the image-recognition method of the embodiment, after the image scanning unit 71 scans an image to be recognized, the image will be transmitted into a central process unit (CPU) 72. After a computer program is executed to receive the image to be recognized in the CPU 72 (step S100), the visual lingual characteristics of the image to be recognized will be determined. (step S110)

Therefore, as for the above visual lingual characteristics and visual vocabularies corresponding them, if the image to be recognized, for example, is a piece of white paper, “2D” is selected to be the visual lingual characteristic corresponding to the “dimension” of the image to be recognized; “smaller than a person's body” is selected to be the visual lingual characteristic corresponding to the “size” of the image to be recognized; “square” and “unfixed” are selected to be visual lingual characteristics corresponding to the “shape” of the image to be recognized; “white” is selected to be the visual lingual characteristic corresponding to the “color” of the image to be recognized; “nonshininess” and “nonreflection” are selected to be the visual lingual characteristic corresponding to the “brightness” of the image to be recognized; “nonmetal” and “nonplastics” are selected to be the visual lingual characteristic corresponding to the “material” of the image to be recognized; “none” is selected to be the visual lingual characteristic corresponding to the “characteristic” of the image to be recognized.

After that, the computer program will be executed in the CPU 72 to select objects 11, 12 according to the above visual lingual characteristics in the database 1 and at least one graphic sample corresponding to the object (step S120). In the embodiment, object 11, 12 will be selected by the logical algorithm so that the number of the objects to be compared will be rapidly decreased in the database 1. The visual lingual characteristics 111˜120, 121˜129 corresponding to the objects 11, 12 are identical to visual lingual characteristics of the image to be recognized.

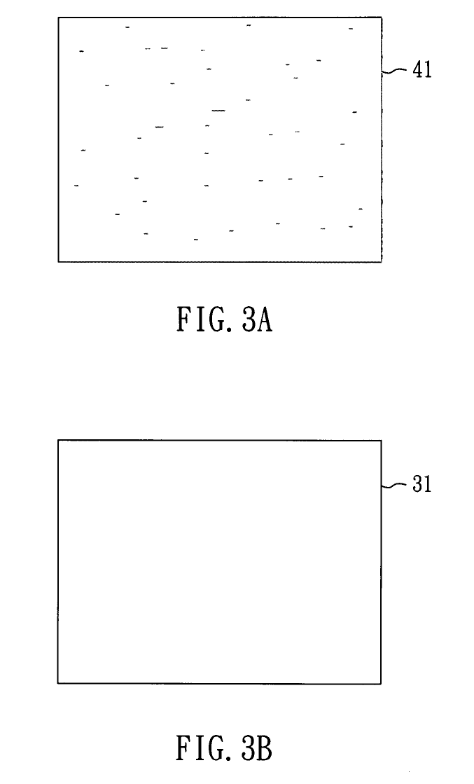

If the image to be recognized is a piece of white paper, take the above database 1 as example, the selection performs in the database 1 by the logical algorithm as the following. Sequentially compare the visual lingual characteristics of the image to be recognized determined by the visual vocabularies with the visual lingual characteristics of objects in the database 1. In the comparison, if one of the visual lingual characteristics 111˜120, 121˜129 of the objects 11, 12 is different from the visual lingual characteristic of the image to be recognized, for example, the visual lingual characteristic 121 “3D” of the object 12 is different from “2D” which is the visual lingual characteristic determined by the corresponding “dimension” of the image to be recognized, then the logical algorithm will not compare according to the visual lingual characteristics “size” 121˜129 of the object 12. That is, when compared sequentially in the database 1, the visual lingual characteristic “small than a personal body” determined according to corresponding “size” of the image to be recognized will not be compared to the visual lingual characteristics 122, 123 of the corresponding “size” 22 of the object 12. Compare sequentially and similarly until all the visual lingual characteristics of the image are used to compare, and the object 11 whose visual lingual characteristics 111˜120 is identical to the visual lingual characteristics of the image to be recognized is selected from the database. After that, the image to be recognized should be compared with the graphic sample. In the embodiment, graphic characteristics of the image to be recognized should be extracted (step S130). Please refer to FIG. 3A and FIG. 3B. Wherein, the FIG. 3A shows an image 21 of a piece of white paper, while FIG. 3B shows a graphic characteristic 31 extracted according to the image shown in FIG. 3A by the image-recognition method of a preferred embodiment of the invention.

In the embodiment, the graphic characteristic 31 belongs a part or a characteristic point of an image 41 to be recognized, and it can be the distribution of color, the change of shape or grain, and so on. In this embodiment, the image to be recognized 41 should be binarization first, and then the graphic characteristic 31 will be obtained by the image process methods such as segmentation, edge detection, thinning, skeletionizing, and so on. However, the graphic characteristic 31 can also be obtained by other image process methods in other embodiments.

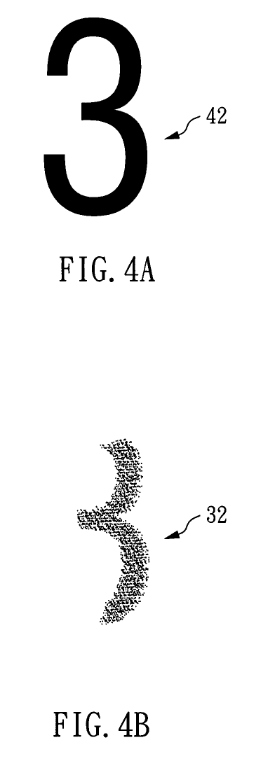

Please refer to FIG. 4A and FIG. 4B. FIG. 4A shows an image 22 of the Arabic number “3”, while FIG. 4B shows a graphic characteristic 32 extracted according to the image shown in FIG. 4A by an image recognition method of another preferred embodiment of this invention.

As shown in the FIG. 4A and FIG. 4B, an image to be recognized 42 is the image of the Arabic number “3”, and the graphic characteristic 32 is the characteristic which is the central section of the image of “3”. After that, the computer program executed in the CPU 72 performs the comparison in graphic samples of objects selected from the step S120 and the image to be recognized (step S140).

If take the object 11 shown in FIG. 2 and graphic characteristic 31 shown in FIG. 3B as examples, in the embodiment, the object 11 should corresponds to two graphic samples 51 and 52 (shown in FIG. 5A and FIG. 5B), and selects from the graphic samples 51, 52 according to the graphic characteristic 31. However the graphic samples 51, 52 of the object 11 of the embodiment are closed frames, that is, the object 11 corresponds to the finite graphic samples 51 and 52.

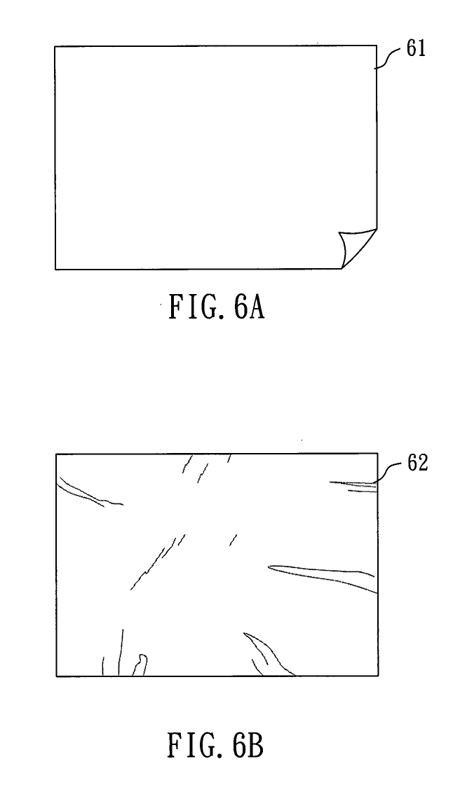

In this embodiment, the similarities between the graphic samples 51, 52 and the graphic characteristic 31 are calculated by a fuzzy logic or a artificial neural network, respectively, so that a graphic sample 41 with the highest similarity is selected. Moreover, before the above steps, at least one of the graphic template 61, 62 (shown in FIG. 6A and FIG. 6B) is used to train the fuzzy logic or the artificial neural network to increase the selecting accuracy. However, in other embodiments, it is not limited to use the fuzzy logic or the artificial neural network in other embodiments.

Moreover, the above executing steps or the computer program of this invention can be written by computer language for convenient performance. The written computer program can be stored in any record media recognized and read by microprocessor unit, or any article or device containing the record media. There is not limited for the article which can be hard disk, diskette, laser disc, ZIP disk, magneto-optical (MO) disk, integrated circuit (IC) chips, random access memory (RAM), or the articles containing the record media used by persons having ordinary skill in the art. Since the automatic refreshing method of the multimedia file of the invention has been disclose completely above, and any person familiar with the computer language will know how to write the computer program after reading the specification, more detailed description about the computer program is omitted here.

Therefore, as stated above, an image-recognition method of this invention includes the following steps: comparing visual lingual characteristics determined by a lingual vocabulary logic according to the image to be recognized to decrease the number of the objects to be compared rapidly, and selecting at least one object; after that, comparing the similarity between the graphic characteristic of the image to be recognized with at least one graphic sample which is a closed frame corresponding to the selected object, and selecting at least one graphic sample so that the image recognition of the open frame is achieved.

The above embodiments are the examples for explaining convenient. The disclosure is not for limiting the scope of the invention. Therefore, the scope of the appended claims should not be limited to the description of the preferred embodiments described above.

What is claimed is:

1. An image-recognition method using a database recording a plurality of objects, at least one visual lingual characteristic corresponding to the objects, and at least one graphic sample corresponding to the objects, the image-recognition method comprising the steps of:
receiving an image to be recognized;
determining at least one visual lingual characteristic of the image to be recognized;
selecting at least one object from the database according to the visual lingual characteristic and at least one graphic sample corresponding to the object; and
comparing the image to be recognized with the selected graphic sample.

2. The image-recognition method according to claim 1, wherein the visual lingual characteristic is a visual vocabulary of human beings for describing the visual characteristic of images, appearance or spatial location relationships.

3. The image-recognition method according to claim 2, wherein the visual vocabulary is selected from the group consisting of dimension, size, shape, color, and brightness.

4. The image-recognition method according to claim 1, wherein the visual lingual characteristic is selected from the group consisting of is noun and adjective.

5. The image-recognition method according to claim 1, wherein the visual lingual characteristic corresponds to a comparative degree.

6. The image-recognition method according to claim 1, wherein the selecting step comprises using a logical algorithm to select the object.

7. The image-recognition method according to claim 1, wherein the steps for comparing the image to be recognized with the graphic sample comprises:
extracting at least one graphic characteristic of the image to be recognized; and,
comparing the graphic characteristic of the image to be recognized with the graphic characteristic of the graphic sample.

8. The image-recognition method according to claim 1, wherein the steps of comparing the extracted graphic characteristic with the graphic sample of selected the plurality of the objects is calculating the similarity between at least one graphic sample and the graphic characteristic, respectively, and selecting the graphic sample with highest similarity.

9. An image-recognition system which includes a database recording a plurality of objects, at least one visual lingual characteristic and at least one graphic sample that the objects correspond to, the image-recognition system comprising:
an image scanning unit for scanning an image to be recognized;
a storage unit for storing the database; and
a central process unit for executing a computer program to determine at least one visual lingual characteristic of the image to be recognized, select at least one object from the database according to the visual lingual characteristic and the object corresponding to at least one graphic sample, and compare the image to be recognized with the graphic sample.

10. The image-recognition system according to claim 9, wherein the visual lingual characteristic is the visual vocabulary of human beings for describing the visual characteristic of images, appearance, or the spatial location relationships.

11. The image-recognition system according to claim 10, wherein the visual vocabulary is selected from the group consisting of dimension, size, shape, color, and brightness.

12. The image-recognition system according to claim 9, wherein the visual lingual characteristic is selected from the group consisting of noun and adjective.

13. The image-recognition system according to claim 9, wherein the visual lingual characteristic corresponds to a comparative degree.

14. The image-recognition system according to claim 9, wherein the selecting steps comprise using a logical algorithm to select the object.

15. The image-recognition system according to claim 9, wherein the steps for comparing the image to be recognized with the graphic sample comprises:
extracting at least one graphic characteristic of the image to be recognized; and,
comparing the graphic characteristic of the image to be recognized with the graphic characteristic of the graphic sample.

16. A computer readable storage medium with a computer program used for image-recognition database recording a plurality of objects, at least one visual lingual characteristic and at least one graphic sample that the objects correspond to; wherein, the above computer program mainly comprises:
codes for determining at least one visual lingual characteristic of the image to be recognized;
codes for selecting at least one object from the database according to the visual lingual characteristic and at least one graphic sample corresponding to the object; and
codes for comparing the image to be recognized with the graphic sample.
